(19) United States
(12) Patent Application Publication
(10) Pub. No.: US 2011/0086222 A1
(43) Pub. Date: Apr. 14, 2011

(54) Selectively-Releasable Adhesives That Include A Glycosominoglycan

(76) Inventors: Howard S. Rosing, Naples, FL (US); Yadong Wang, Allison Park, PA (US)

(21) Appl. No.: 12/577,463

(22) Filed: Oct. 12, 2009

(51) Int. Cl. B32B 7/12; C08G 63/91; B32B 37/02

(52) U.S. Cl. 428/355 CP; 525/54.2; 156/230; 156/155

(57) ABSTRACT

In one embodiment, a selectively-releasable adhesive includes a copolymer formed from a multifunctional alcohol, a multifunctional carboxylic acid, and a glycosaminoglycan (GAG). In one embodiment, an adhesive article includes a backing material having a surface and a layer of adhesive provided on the surface, the adhesive layer having an outer surface opposite to a surface that contacts the backing material, the outer surface being at least partly composed of a copolymer formed from a multifunctional alcohol, a multifunctional carboxylic acid, and a glycosaminoglycan (GAG).

### BACKGROUND

Adhesives are used in many applications, including consumer, industrial, and medical applications. Although some adhesives are intended to form a permanent or semi-permanent bond with the items to which they are applied, many adhesives are used in less permanent applications. The latter type of adhesives are often used in applications in which an article is to be affixed to something else and later removed. An example is the common adhesive bandage strip, which is intended to stick to the skin until the wearer wishes to remove the bandage strip.

A problem with the adhesives that are used in temporary applications is that the adhesive may still adhere well to an object to which it has been applied when the time for removal has arrived. For example, in the case of an adhesive bandage strip, such adhesion can make it more difficult to remove the bandage strip and therefore may cause discomfort to the wearer. Although such discomfort may be relatively mild, the discomfort level from removal of other types of dressings can be much greater. For example, removal of medical tape from the skin of a burn patient can not only cause the patient a great deal of pain, but further cause tissue damage. In addition, the removal of medical tape or surgical dressings from an elderly patient can frequently cause significant discomfort as well as bruising and/or bleeding.

### BRIEF DESCRIPTION OF THE DRAWINGS

The disclosed adhesives can be better understood with reference to the following drawings. The components in the drawings are not necessarily to scale.

FIG. 1 is a schematic illustration of the chemical structure of a selectively-releasable adhesive.

FIG. 2 is a diagram that illustrates an example chemical structure for a compound used to prepare a selectively-releasable adhesive.

FIG. 3 is a perspective view of an embodiment of adhesive tape that incorporates a selectively-releasable adhesive.

FIG. 4 is a side view of the adhesive tape of FIG. 3.

FIG. 5 is a side view of an embodiment of an adhesive bandage strip that incorporates a selectively-releasable adhesive.

FIG. 6 is a front view of a patient to which adhesive ECG leads that incorporate a selectively-releasable adhesive have been applied.

FIG. 7 is a top view of an embodiment of an ECG lead shown in FIG. 6.

FIG. 8 is a flow diagram that describes an embodiment of a method for making a selectively-releasable adhesive article.

FIG. 9 is a diagram that illustrates an example poly(diglyceryl decanedioate)-co-hyaluronan (PDDH) adhesive.

FIG. 10 is a side view of a further embodiment of an adhesive tape that incorporates a selectively-releasable adhesive.

### DETAILED DESCRIPTION

As described above, it can be difficult to remove articles that have been affixed to an object using conventional adhesives. Moreover, in cases in which the article is a dressing and the object is a patient, pain and/or tissue damage can occur from such removal. Described in the following are adhesives that lose much of their adhesive strength when a solvent is applied. Therefore, such adhesives can be used in applications in which selective release of the adhesive or an article to which the adhesive is applied is desired. In some embodiments, the adhesive comprises poly(diglyceryl decanedioate)-co-hyaluronan (PDDH) and the solvent comprises an alcohol. Example applications for the adhesives include use in glues and adhesive tapes, as well as dressings, such as adhesive bandages/strips, surgical dressings, and the like.

In the following, various embodiments of adhesives and articles that incorporate adhesives are described. Although specific embodiments are presented, those embodiments are mere exemplary implementations and, therefore, other embodiments are possible. All such embodiments are intended to fall within the scope of this disclosure.

### Adhesive Compound Preparation and Characteristics

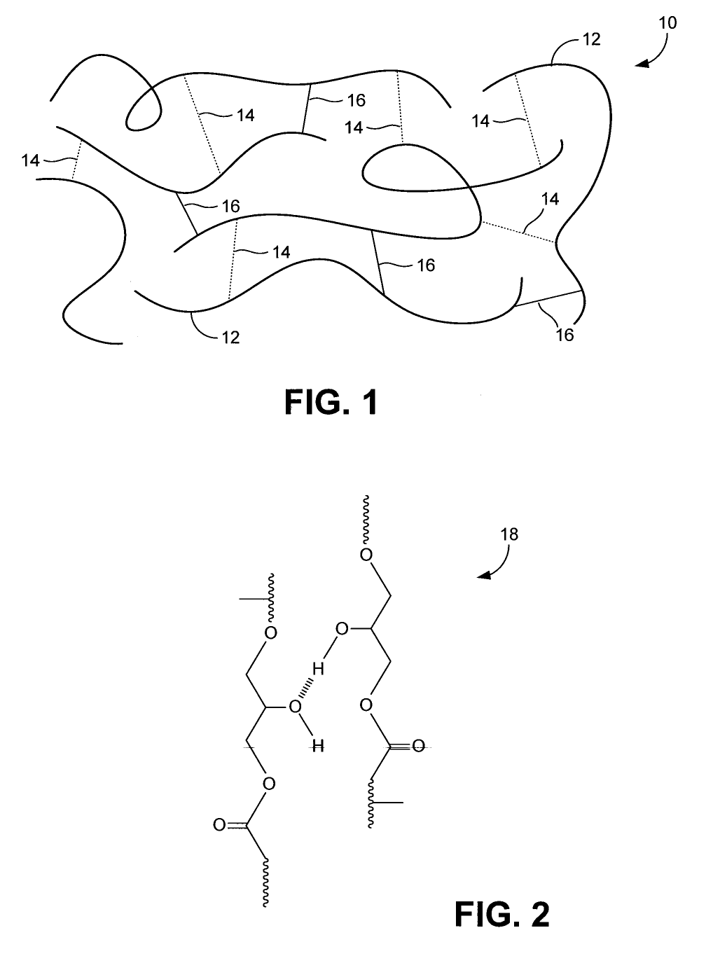

Referring now to the figures, in which like reference numerals identify corresponding features, FIG. 1 schematically illustrates an adhesive compound or polymer 10, referred to herein simply as “adhesive.” As indicated in that figure, the adhesive 10 includes a polymer backbone 12 and a plurality of chemical bonds including hydrogen bonds 14 and covalent bonds 16. As is apparent from FIG. 1, there are a relatively large number of hydrogen bonds 14 as compared to covalent bonds 16.

In some embodiments, the adhesive 10 comprises a copolymer formed from a multifunctional alcohol, a multifunctional carboxylic acid, and a glycosominoglycan (GAG). As used herein, the term “multifunctional alcohol” refers to any alcohol that has two or more hydroxyl (—OH) groups, and the term “multifunctional carboxylic acid” refers to any carboxylic acid that has two or more acid (—COOH) groups. Example multifunctional alcohols include glycerol, monomeric carbohydrates such as glucose and mannose, and small polyols such as oligo (vinyl alcohol). Example multifunctional carboxylic acids include diacids such as decanedioic acid, succinic acid, oxylic acid, and malic acid; and triacids such as citric acid. Example GAGs include chondroitin sulfate, dermatan sulfate, keratan sulfate, heparin, heparin sulfate, or hyaluronic acid. One example of such a copolymer is poly(diglyceryl decanedioate)-co-hyaluronan (PDDH). An example of preparation of PDDH is described in the following several paragraphs.

Decanedioic acid can be rigorously purified prior to synthesis of poly(diglyceryl decanedioate) (PDD), the precursor to PDDH, to improve the quality of the resultant polymer. Such purification can be performed by combining a relatively small amount of 1,10-decanedioic acid with a relatively large amount of ethanol and heating the mixture until the decanedioic acid completely dissolves. Once the decanedioic acid has dissolved, the hot decanedioic acid solution can be filtered under a vacuum and the filtrate can be refrigerated for several hours to enable crystallization. The decanedioic acid crystals are then collected and intermittently filtered under vacuum to collect the crystals. After the completion of the filtration, the above process (dissolution, crystallization, and filtration) can be repeated multiple times (e.g., 3-4 times) to ensure a high level of purification. Thereafter, the air-dried decanedioic acid crystals can be heated under a vacuum to remove any residual ethanol or moisture.

Once the decanedioic acid has been purified, it can be used to synthesize PDD. Such synthesis can be accomplished through melt polycondensation of an approximately 0.5:1.0 to 1.5:1.0 molar ratio of glycerol to purified decanedioic acid at an elevated temperature, such as approximately 120° C. In some embodiments, an equimolar amount (i.e., a 1.0:1.0 ratio) of glycerol and decanedioic acid may be used. The reaction can, for example, be carried out under nitrogen gas (N₂) flow. The mixture can be stirred and water distilled from the reaction can be trapped and removed. The compound that results is a prepolymer of glycerol and decanedioic acid, i.e., PDD prepolymer. As used herein, the term “prepolymer” describes the polymer prior to curing. Accordingly, the prepolymer exhibits no crosslinking.

After the PDD prepolymer has been synthesized, it can be polymerized using a curing process. In some embodiments, the prepolymer is first mixed with solvent to form a solution that can be sprayed on a suitable non-stick surface. Once the solvent evaporates, a film of PDD prepolymer remains on the surface that can be cured in an oven over a period of several hours. FIG. 2 illustrates the chemical structure of an embodiment of a resultant PDD polymer 18, and the hydrogen bonding that occurs between chains of the polymer.

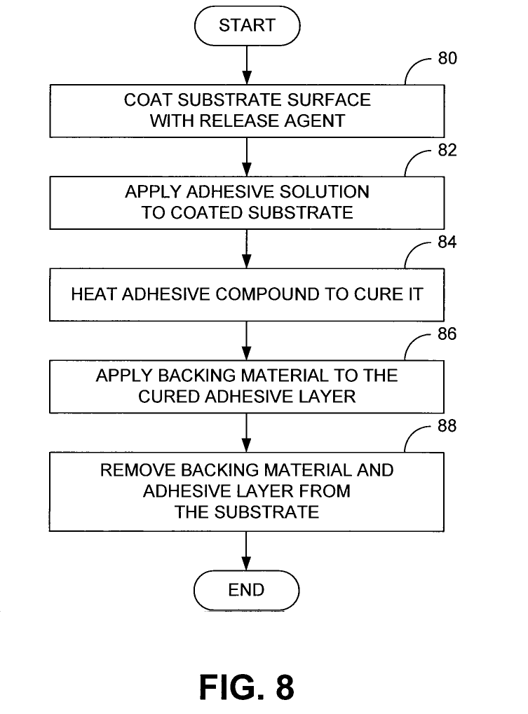

When the PDD, or another adhesive compound, is to be provided on an article such as tape or an adhesive dressing, the compound can be applied to backing material of the article prior to curing. In other embodiments, the compound can be transferred to a backing material after curing. An example of the latter process will now be described in relation to the flow diagram of FIG. 8.

Beginning with block 80 of FIG. 8, a surface of a substrate is first coated with a release agent. By way of example, the substrate is a flat substrate composed of a hard, temperature-resistant material, such as glass or metal. In some embodiments, the release agent comprises a glycosaminoglycan (GAG), such as chondroitin sulfate, dermatan sulfate, keratan sulfate, heparin, heparin sulfate, or hyaluronic acid. Of those GAGs, hyaluronic acid (also referred to as hyaluronan or hyaluronate) may be particularly suitable due to its high solubility and biocompatibility. By way of example, the release agent is an aqueous solution comprising approximately 0.1% to 10% GAG by weight. The release agent can be applied to the substrate in substantially any way in which the substrate surface is coated so that an adhesive compound to be applied to the substrate will directly contact the coating instead of the bare substrate surface. Example application methods for the release agent include pouring or depositing droplets of release agent on the substrate, spraying the substrate with release agent, and roller coating the substrate with release agent. The solvent within the release agent evaporates to leave dry release agent coated on the substrate.

After the substrate has been coated with the release agent, an adhesive compound solution (prepolymer) is applied to the coated substrate, as indicated in block 82. As with the release agent, example application methods for the adhesive compound include pouring or depositing droplets of the compound solution on the substrate, spraying the substrate with compound solution, and roller coating the substrate with compound solution. Irrespective of the manner in which the adhesive compound solution is applied to the substrate, the solution evenly spreads across the substrate at least in part due to the presence of the release agent, which prevents the adhesive compound from adhering to the substrate surface and enables the compound to level. The adhesive compound solution mixes and bonds with the release agent to form a hybrid adhesive compound. In embodiments in which the adhesive compound is poly(diglyceryl decanedioate) (PDD) and the release agent is hyaluronic acid, the hybrid adhesive compound is poly(diglyceryl decanedioate)-co-hyaluronan (PDDH).

Once the solvents have dried, the hybrid adhesive compound is heated, as indicated in block 84, to cure the compound on the substrate and form an adhesive layer. In some embodiments, heating comprises placing the substrate within an oven and heating the substrate and adhesive layer at an elevated temperature for several hours. By way of example, curing can be performed for the equivalent of approximately 6 to 12 hours at approximately 120° C. and 100 milliTorr. In other embodiments, curing is performed for the equivalent of approximately 8 to 10 hours at approximately 120° C. and 100 milliTorr. In still other embodiments, curing is performed for the equivalent of approximately 9 hours at approximately 120° C. and 100 milliTorr.

After curing has been completed, but before the adhesive layer cools to room temperature, backing material is applied to adhesive layer, as indicated in block 86, to adhere the backing material to the adhesive layer. By way of example, the backing material can be in the form of a cloth or a film. Regardless, example materials include cellulosic materials such as cotton; polymeric materials such as polyester, polyvinyl chloride, and polyethylene; and composite materials, which can include an elastic material, such as Spandex, that gives the resultant fabric elasticity. Once the backing material has been adhered to the adhesive, the backing material and the adhesive layer can be removed from the substrate, as indicated in block 88. In some embodiments, removal is performed by first rinsing the substrate with water or an appropriate aqueous solution. For example, the substrate can be immersed in water, or water can be sprayed on the substrate. Such actions dissolve most of the release agent and enables the backing material to be peeled off of the substrate along with the adhesive layer. Notably, however, a thin layer of the release agent may remain on the surface of the adhesive layer opposite to that which contacts the backing material.

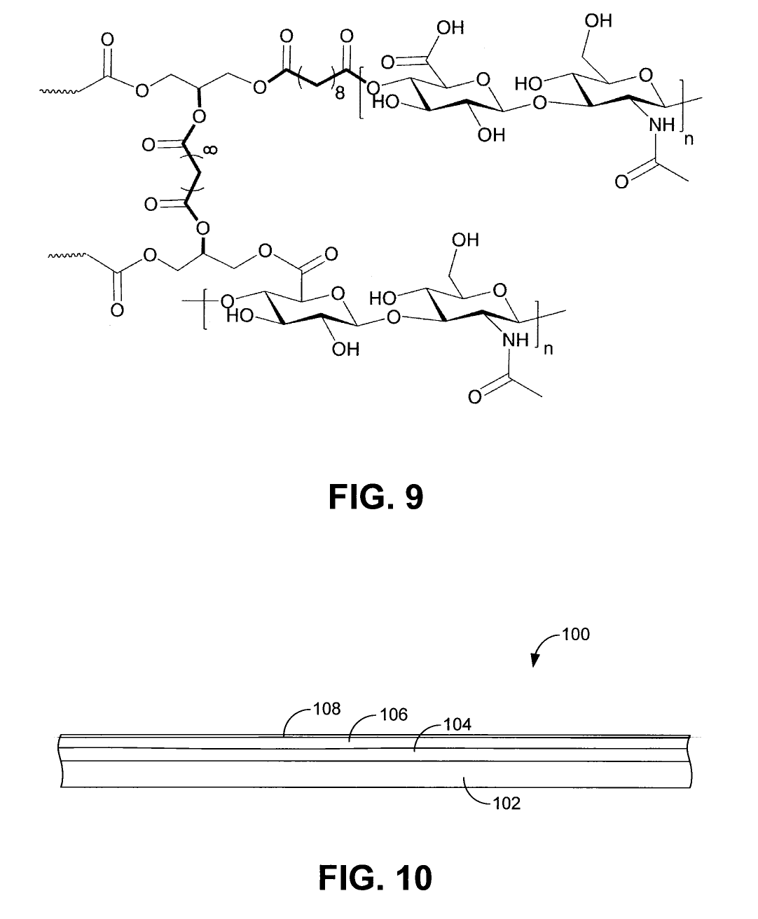

FIG. 9 illustrates an example adhesive that can be produced using the above-described procedure. More particularly, FIG. 9 is a diagram of an example PDDH polymer that results from ester bond formation between PDD and hyaluronic acid. Notably, there are several other ways in which PDD and hyaluronic acid can bond to form PDDH because both polymers contain numerous hydroxyl and carboxylic acid groups that allow multiple ester bond formations via direction condensation or transesterification. In cases in which PDDH is formed, an adhesive article can include backing material, PDD, PDDH, and possibly hyaluronic acid. Such an article 100 is illustrated in FIG. 10, which shows a backing material 102, a PDD layer 104, a PDDH layer 106, and residual hyaluronic acid 108.

The above-described process provides various advantages. For one, an article having a very uniform layer of adhesive compound results. In addition, because the backing material is not heated, even backing materials without high melting temperature can be used.

As mentioned above, the adhesive strength of the disclosed adhesive can be selectively reduced through the application of a solvent. Suitable solvents include alcohols, such as isopropyl alcohol, ethanol, 1-propanol, 2-propanol, and 1-butanol; ketones, such as acetone, and methyl ethyl ketone; ethers, such as tetrahydrofuran and diethyl ether; amides, such as N,N-dimethyl foramide; sulfoxides, such as dimethyl sulfoxide; and esters, such as ethyl acetate. Because a suitable solvent is required to reduce the adhesive strength, adhesive and articles employing the adhesive are substantially waterproof or at least water resistant. Medical tape or dressings incorporating the adhesive can be expected to remain affixed to skin for at least 48 hours if not exposed to the solvent. In some cases such tape/dressings can be removed using solvent and later replaced on the skin without significant loss of adhesive strength once the solvent has evaporated.

In some embodiments, the adhesive strength of the selectively-releasable adhesive is retained at least 7 months after preparation. Degradation of the adhesive can be avoided or reduced by storing the adhesive in a moisture-free environment, such as in a vacuum or in a water-free gas. In some embodiments, it may be desirable to store articles to which the selectively-releasable adhesive is applied in sealed packages under vacuum and/or that contain an inert gas until the time of use.

### Example of Adhesive Preparation

Samples of selectively-releasable adhesive were prepared in a laboratory by adding 100 grams (g) of decanedioic acid to a 2 L round bottom flask along with 1 L of 95/5 blend of ethanol and water. The flask was heated in a 55° C. water bath until the decanedioic acid completely dissolved. Once the decanedioic acid dissolved, the hot decanedioic acid solution was filtered through a 0.45 micron (μm) nylon filter under a vacuum.

The filtrate was then transferred to a clean 2 L Erlenmeyer flask, allowed to cool to room temperature, and then stored at 4° C. overnight (approximately 8 hours) to enable crystallization. The next day, decanedioic acid crystals were collected with a 0.22 μm filtration setup under a vacuum. The crystals were maintained under the vacuum and intermittently stirred for 3 to 4 days until the ethanol evaporated.

The above process was then repeated multiple times and the air-dried decanedioic acid crystals were transferred to a 2 L glass beaker that was placed in a vacuum oven. A vacuum was applied until the oven reached a full vacuum of 90 to 100 mTorr, and then the oven was set to temperature to 60° C., which was arrived at in 1° C./min steps. The decanedioic acid crystals were then maintained at 60° C. for a period of 16 hours.

Once the decanedioic acid was purified in the manner described above, it was used to synthesize the PDD prepolymer by melt polycondensation. Equimolar amounts of glycerol (34.45 g) and purified decanedioic acid (75 g) were heated to approximately 120° C. in a 500 milliliter (ml) three-neck flask equipped with a Dean-Stark trap under N₂ flow. The mixture was stirred at atmospheric pressure with a 1¼ inch×⅝ inch, egg-shaped stir bar having a weight of 15.5 g at stir rate of approximately 500 revolutions per minute (rpm). Water was collected in the trap during the stirring. Once no more water collected in the trap, a vacuum was gradually applied over approximately one hour until the pressure stabilized at approximately 100 mTorr to 150 mTorr. The reaction was permitted to progress until the maximum stir rate was reduced to approximately 10 rpm (after approximately 72-90 hours).

The PDD prepolymer was then was dissolved in THF to form a 30% PDD solution and the solution was sprayed onto a glass substrate coated with hyaluronic acid. The THF was permitted to evaporate until only a film of PDD prepolymer remained. The substrate was then transferred to a vacuum oven and the PDD prepolymer was cured with direct contact of the hyaluronan coating at 120° C. at 100 mTorr for 9 hours, resulting in the formation of a selectively-releasable adhesive comprising PDD and PDDH polymer. After curing, polyester backing material was applied to the adhesive layer. Next, the substrate was immersed in water and the backing material, along with the adhesive, was removed from the substrate, yielding an adhesive tape comprising a layer of PDD that directly contacts the backing material, and a layer of PDDH that can contact skin or other surface during application of the tape.

### Example Applications

The selectively-releasable adhesive described in the foregoing can be used in various applications, including consumer, industrial, and medical applications. Described in the following are examples of such applications.

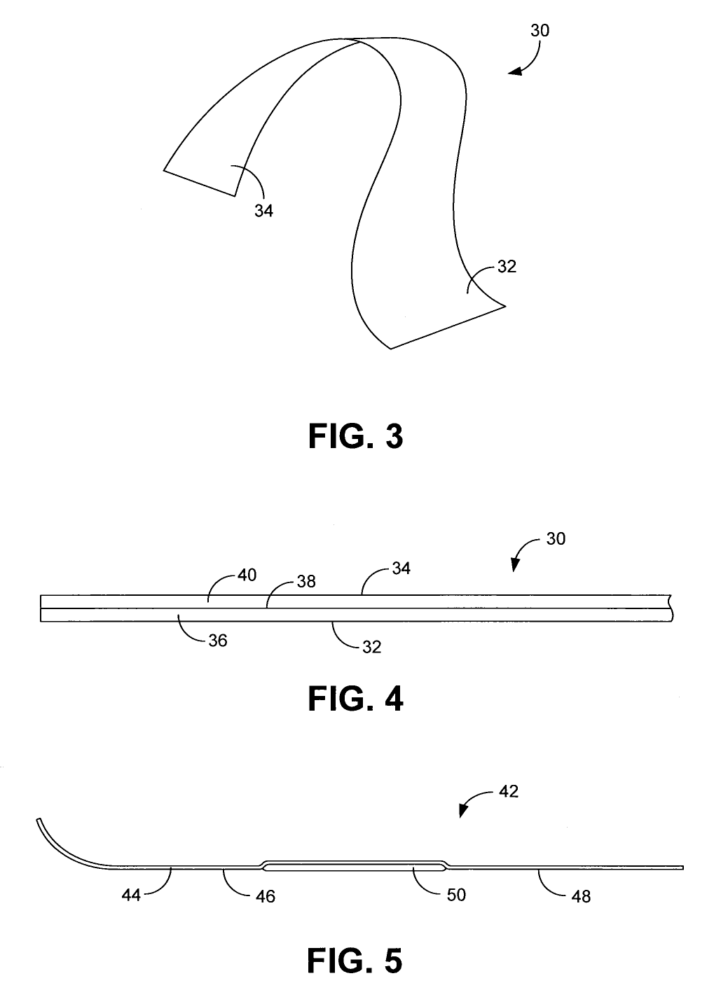

FIG. 3 illustrates an embodiment of adhesive tape 30 that incorporates the selectively-releasable adhesive. By way of example, the tape 30 can be used in medical applications to secure dressings or other articles to a patient's skin. The tape 30 generally comprises a continuous, thin, and flexible strip having an outer side 32 and an inner side 34. FIG. 4 illustrates an example construction that can be used to form the tape 30. In the embodiment of FIG. 4, the tape 30 includes a substrate 36 having an inner surface 38 to which has been applied an adhesive layer 40 that comprises the above-described selectively-releasable adhesive. In some embodiments, the substrate 36 comprises a flexible material that is adapted to conform to the contours of subjects to which the tape 30 is applied. Example constructions for the substrate 36 include layers of paper, fabrics, textiles, polymers, foam, polyvinyl chloride, polyethylene, and foil. Irrespective of the material used, the substrate 36 preferably is porous so that a solvent applied to the exterior of the tape 30 can reach the adhesive layer 40 to facilitate release. Porosity may not be required, however. For example, pores may not be needed in cases in which solvent is applied along the border of the tape 30 and the tape is gradually peeled off to expose further adhesive to which additional solvent can be applied. By way of example, the adhesive layer 40 is approximately 10 to 200 μm thick. In some cases, residual release compound (not visible in the figure) may remain on the outer surface of the adhesive layer 40.

FIG. 5 illustrates an adhesive bandage strip 42 that incorporates the selectively-releasable adhesive. As indicated in FIG. 5, the bandage strip 42 includes a substrate 44 having an inner surface 46 to which has been applied an adhesive layer 48 that comprises the above-described selectively-releasable adhesive. As with the substrate 36, the substrate 44 can comprise a flexible material that is adapted to conform to the contours of subjects to which the bandage strip 42 is applied. Example constructions for the substrate 44 include layers of paper, fabrics, textiles, polymers, foam, polyvinyl chloride, polyethylene, and foil. Irrespective of the material used, the substrate 44 is preferably porous so that a solvent applied to the exterior of the bandage strip 42 can reach the adhesive layer 48 to facilitate release. By way of example, the adhesive layer 48 is approximately 10 to 400 μm thick. As is further indicated in FIG. 5, the bandage strip 42 includes a central dressing element 50 designed to overlie a cut or other wound. In some cases, residual release compound (not visible in the figure) may remain on the outer surface of the adhesive layer 40.

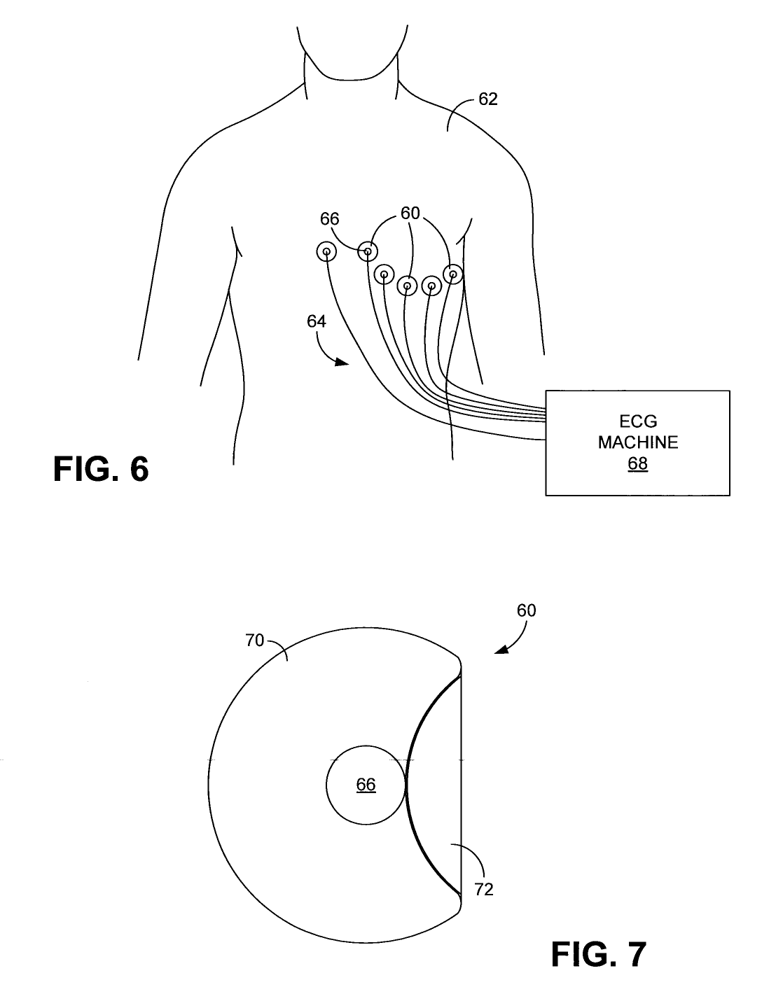

There are various other applications for the selectively-releasable adhesive beyond adhesive tape and bandages. FIG. 6 illustrates one example of such an application. Specifically, illustrated in FIG. 6 are multiple adhesive electrocardiogram (ECG) leads 60 that have been applied to a patient 62. As indicated in the figure, wires 64 extend from electrodes 66 provided on the leads 60 to an ECG machine 68. FIG. 7 illustrates an example configuration for one of the ECG leads 60. As indicated in FIG. 7, the ECG lead 60 comprise a substrate 70 to which is applied an adhesive layer 72 that comprises the selectively-releasable adhesive.

As stated above, the present disclosure describes various embodiments of adhesives and articles that incorporate an adhesive. It is reiterated that those embodiments are mere exemplary implementations. Accordingly, although PDD/PDDH adhesive has been described in detail, adhesives consistent with this disclosure may be composed of other materials. In addition, although medical uses of the adhesives have been described in detail, non-medical uses of the disclosed adhesives are possible, including use of the adhesives in non-medical tape or stickers. Moreover, although adhesive articles have been described, the disclosed adhesives could be used as glue, whether it be in a medical or non-medical context.

1. A selectively-releasable adhesive comprising:
a copolymer formed from:
a multifunctional alcohol,
a multifunctional carboxylic acid, and
a glycosaminoglycan (GAG).

2. The selectively-releasable adhesive of claim 1, wherein the multifunctional alcohol comprises one or more of glycerol, a monomeric carbohydrate, and a small polyol.

3. The selectively-releasable adhesive of claim 1, wherein the multifunctional alcohol comprises glycerol.

4. The selectively-releasable adhesive of claim 1, wherein the multifunctional carboxylic acid comprises one or more of a diacid and a triacid.

5. The selectively-releasable adhesive of claim 1, wherein the multifunctional carboxylic acid comprises decanedioic acid.

6. The selectively-releasable adhesive of claim 1, wherein the a glycosaminoglycan (GAG) comprises one or more of chondroitin sulfate, dermatan sulfate, keratan sulfate, heparin, heparin sulfate, and hyaluronic acid.

7. The selectively-releasable adhesive of claim 1, wherein the glycosaminoglycan (GAG) comprises hyaluronic acid.

8. The selectively-releasable adhesive of claim 1, wherein the multifunctional alcohol comprises glycerol, the multifunctional carboxylic acid comprises decanedioic acid, the glycosaminoglycan (GAG) comprises hyaluronic acid, and the adhesive comprises poly(diglyceryl decanedioate)-co-hyaluronan (PDDH).

9. A method for making an adhesive article, the method comprising:
coating a substrate with a release agent;
applying an adhesive solution to the coated substrate;
curing the adhesive solution in place on the coated substrate to form a cured adhesive layer;
applying a backing material to the cured adhesive layer; and
removing the backing material along with the cured adhesive layer from the substrate to obtain an adhesive article.

10. The method of claim 9, wherein coating a substrate comprises coating the substrate with a glycosaminoglycan (GAG) solution.

11. The method of claim 9, wherein coating a substrate comprises coating the substrate with a hyaluronic acid solution.

12. The method of claim 9, wherein applying an adhesive solution comprises applying a selectively-releasable adhesive solution to the coated substrate.

13. The method of claim 9, wherein the adhesive solution comprises a copolymer formed from a multifunctional alcohol and a multifunctional carboxylic acid.

14. The method of claim 9, wherein the adhesive solution comprises poly(diglyceryl decanedioate) (PDD).

15. The method of claim 9, wherein curing the adhesive solution comprises heating the adhesive solution in an oven.

16. The method of claim 9, wherein curing comprises curing the adhesive solution the equivalent of approximately 6 to 12 hours at approximately 120° C. and 100 milliTorr.

17. The method of claim 9, wherein curing comprises curing the adhesive solution the equivalent of approximately 8 to 10 hours at approximately 120° C. and 100 milliTorr.

18. The method of claim 9, wherein curing comprises curing the adhesive solution the equivalent of approximately 9 hours at approximately 120° C. and 100 milliTorr.

19. The method of claim 9, wherein applying a backing material comprises applying a cellulosic backing material to the adhesive layer.

20. The method of claim 9, wherein applying a backing material comprises applying a polymeric backing material to the adhesive layer.

21. The method of claim 9, further comprising rinsing the substrate with water or an aqueous solution prior to removing the backing material and the cured adhesive layer from the substrate.

22. A method for making an adhesive article, the method comprising:
synthesizing a poly(diglyceryl decanedioate) (PDD) prepolymer solution;
coating a substrate with a glycosaminoglycan (GAG) solution;
applying the poly(diglyceryl decanedioate) (PDD) prepolymer solution to the coated substrate;
curing the poly(diglyceryl decanedioate) (PDD) prepolymer solution in place on the coated substrate to form an adhesive layer that comprises poly(diglyceryl decanedioate)-co-hyaluronan (PDDH);
applying a backing material to the adhesive layer;
rinsing the backing material, adhesive layer, and substrate to dissolve at least some of the GAG solution; and
removing the backing material along with the adhesive layer from the substrate to obtain an adhesive article.

23. An adhesive article comprising:
a backing material having a surface;
a layer of adhesive provided on the surface of the backing material, the adhesive layer having an outer surface opposite to a surface that contacts the backing material, the outer surface being at least partly composed of a copolymer formed from a multifunctional alcohol, a multifunctional carboxylic acid, and a glycosaminoglycan (GAG).

24. The article of claim 23, wherein the backing material is a fabric.

25. The article of claim 23, wherein the backing material is a film.

26. The article of claim 23, wherein the backing material comprises a cellulosic material.

27. The article of claim 23, wherein the backing material comprises a polymeric material.

28. The article of claim 23, wherein the adhesive layer comprises poly(diglyceryl decanedioate)-co-hyaluronan (PDDH).

29. The article of claim 23, wherein the glycosaminoglycan (GAG) is hyaluronic acid.

30. The article of claim 23, wherein the article is adhesive tape.

31. The article of claim 23, wherein the article is an adhesive dressing.
